(19) United States
(12) Patent Application Publication
(10) Pub. No.: US 2016/0129952 A1
(43) Pub. Date: May 12, 2016

(54) Vehicle Spare Tire Stowage Assembly

(71) Applicant: Ford Global Technologies, LLC, Dearborn, MI (US)

(72) Inventors: Iskander Farooq, Novi, MI (US); Mohammed Omar Faruque, Ann Arbor, MI (US); Dean M. Jaradi, Macomb, MI (US)

(21) Appl. No.: 14/534,512

(22) Filed: Nov. 6, 2014

(51) Int. Cl. B62D 43/04

(52) U.S. Cl. CPC B62D 43/04

(57) ABSTRACT

A tire stowage assembly for a vehicle is provided. The tire stowage assembly may include a housing, an output shaft, an arm, and a slidable member. The housing may be secured to a location adjacent a spare tire and defines a receiving cavity. The output shaft may at least be partially disposed within the housing and configured for linear translation and rotation. The arm may extend laterally from the shaft. The slidable member may be operably connected to the arm for linear translation and configured to support the spare tire. The output shaft and slidable member may be further configured to cooperate to move the tire from a stowed to a deployed position. The stowed position may be defined as a position in which the spare tire is secured beneath an undercarriage of a vehicle. The deployed position may be defined as a position in which at least a portion of the spare tire is rearward of an undercarriage of a vehicle.

### TECHNICAL FIELD

This disclosure relates to an assembly for deploying a stowed spare tire for a vehicle.

### BACKGROUND

A spare tire for a vehicle, such as a pickup truck or sport utility vehicle, is commonly stored and secured to an undercarriage and/or frame of the vehicle. Removing the spare tire to replace a failed tire is often a cumbersome task, which may be made more difficult if this task must be done on a roadside. A bracket assembly is one example of a device which may secure the spare tire to the undercarriage. A driver may have to crawl underneath the vehicle to access the bracket assembly and spare tire. Once removed from the bracket assembly, the spare tire must then be moved from underneath the vehicle, which may be difficult for the driver in and of itself due to a weight of the spare tire.

### SUMMARY

A tire stowage assembly includes a housing, an output shaft, an arm, and a slidable member. The housing is secured to a location adjacent a spare tire and defines a receiving cavity. The output shaft is at least partially disposed within the housing and configured for linear translation and rotation. The arm extends laterally from the shaft. The slidable member is operably connected to the arm for linear translation and configured to support the spare tire. The output shaft and slidable member are further configured to cooperate to move the tire from a stowed to a deployed position. The stowed position may be defined as a position in which the spare tire is secured beneath an undercarriage of a vehicle. The deployed position may be defined as a position in which at least a portion of the spare tire is rearward of an undercarriage of a vehicle. The assembly may also include a support rod, a support plate, and a bracket. The support rod may be secured to the slidable member and define an upper portion for receiving the spare tire. The support plate may be secured to the support rod below the upper portion. The bracket may be configured to fasten to the upper portion such that the spare tire is disposed between the support plate and the bracket. The assembly may include a linear-rotary actuator operably connected to the output shaft, a linear actuator operably connected to the slidable member, a power source electrically connected to the actuators, and a switch in communication with the actuators such that a triggering of the switch activates the actuators for a powered delivery of the tire to the deployed position. The linear-rotary actuator may be configured to lower the spare tire a distance such that the spare tire clears any adjacent vehicle components when transitioning to the deployed position.

A tire stowage assembly includes a first actuator and a second actuator. The first actuator includes an output shaft. The first actuator is configured for securing to a vehicle undercarriage, and is configured to rotate and linearly translate the shaft. The second actuator extending laterally from the shaft and includes a slidable member configured to support a spare tire. The actuators cooperate with one another to move the spare tire from a stowed position adjacent to the undercarriage to a deployed position at least partially rearward of the undercarriage. The assembly may include a support rod extending from the slidable member and defining a rod axis, and the output shaft may define a shaft axis at least substantially parallel to the rod axis. The undercarriage and an underlying surface may define a region therebetween, and the slidable member may be further configured to translate linearly to move at least a portion of the spare tire outside of the region. The stowed position may be further defined as a position in which the spare tire is secured substantially close to the undercarriage. The deployed position may be further defined as a position in which at least a portion of the spare tire is rearward of the undercarriage. The assembly may include a power source electrically connected to the actuators and a switch in communication with the actuators such that triggering the switch activates the actuators for a powered delivery of the tire between the stowed and the deployed positions. The switch may be located within a vehicle cabin or may be integrated with a remote device.

A vehicle includes a frame and a tire stowage assembly. The tire stowage assembly includes operably connected linear-rotary and linear actuators configured to support a spare tire in a stowed and a deployed position. The linear-rotary actuator is affixed to the frame to provide vertical translation and rotation to lower and pivot the spare tire from the stowed position. Extension of the linear actuator delivers the tire to the deployed position. The vehicle may also include a switch to control power flow to the actuators such that triggering the switch activates a powered delivery of the tire between the stowed and deployed positions. The stowed position may be further defined as a position in which the spare tire is secured proximate to an undercarriage of the vehicle. The deployed position may be further defined as a position in which the spare tire is at least partially disposed rearward of the vehicle. The linear-rotary actuator may include a housing affixed to an undercarriage of the vehicle. The output shaft may at least be partially disposed within the housing and configured to move an arm supporting the spare tire a distance such that the spare tire is below the undercarriage. The linear actuator may include a slidable member configured to translate the spare tire rearward of an undercarriage of the vehicle. The vehicle may include a support rod secured to a slidable member of the linear actuator. The support rod may define an upper portion to support the spare tire. A support plate may be secured to the slidable member below the upper portion. A handle may be configured to fasten to the upper portion such that the spare tire is retained between the support plate and handle

### BRIEF DESCRIPTION OF THE DRAWINGS

FIG. 1 is a rear view of an example of a vehicle.

FIG. 2 is a lower rear perspective view of the vehicle of FIG. 1 showing a spare tire secured to an undercarriage of the vehicle.

FIG. 3 is an upper rear perspective view of the vehicle of FIG. 1 with portions of the vehicle removed to show the spare tire of FIG. 2.

FIG. 4A is a perspective view of an example of a tire stowage assembly.

FIG. 4B is a perspective view of an example of a linear-rotary actuator.

FIG. 4C is a cutaway perspective view the linear-rotary actuator of FIG. 4B.

FIG. 5A is a schematic side view of a portion of the vehicle of FIG. 1 showing an example of a tire stowage assembly supporting a spare tire in a stowed position.

FIG. 5B is a schematic side view of the tire stowage assembly of FIG. 5A showing the spare tire supported in another position.

FIG. 5C is a schematic side view of the tire storage assembly of FIG. 5A showing the spare tire supported in yet another position.

FIG. 5D is a schematic side view is a side view of the tire storage assembly of FIG. 5A showing the spare tire supported in a deployed position.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

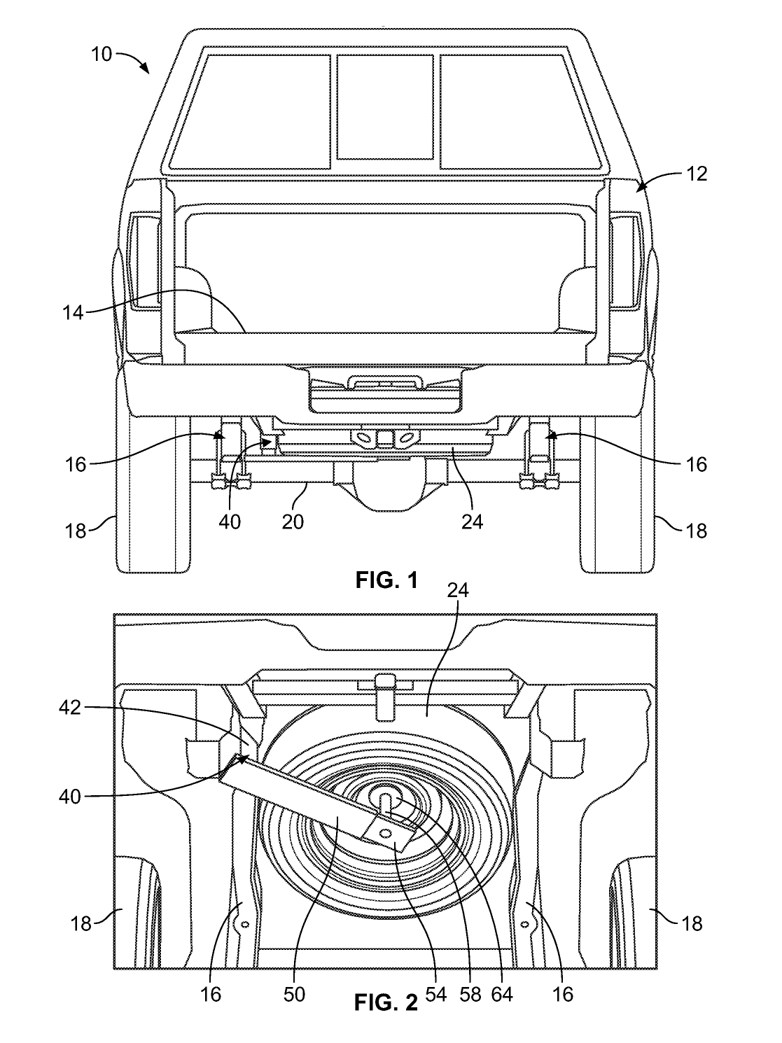

FIG. 1 shows an example of a rear portion of a vehicle, generally referred to as a vehicle 10 herein. The vehicle 10 may include a truck box 12 and a truck bed 14 supported by a frame 16. A plurality of tires 18 may be attached for rotation to one or more axles 20 which are operably connected to the frame 16. The frame 16 and other components beneath the truck box 12 and truck bed 14 may be referred to as an undercarriage of the vehicle 10. There is a region between the undercarriage and an underlying surface supporting the vehicle 10. A spare tire 24 may be secured to the frame 16 and within the region. FIG. 2 shows a lower perspective view of the spare tire 24 and a portion of the undercarriage of the vehicle 10.

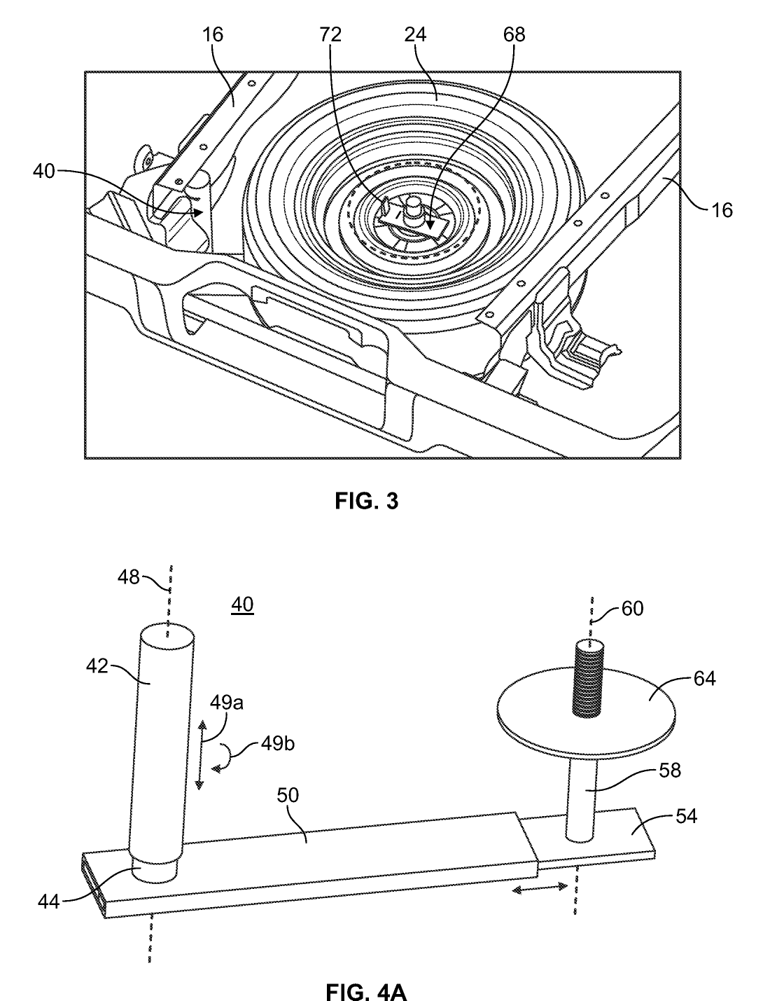

FIG. 3 shows a portion of the vehicle 10 with components removed, such as the truck box 12 and the truck bed 14, to further show one example of a location for the spare tire 24 to be secured to the frame 16 and underneath the truck bed 14. A tire stowage assembly may operably connect the spare tire 24 to the frame 16. The tire stowage assembly may assist in moving the spare tire 24 between a stowed position and a deployed position. While the vehicle 10 is shown as a pickup truck in this disclosure, it is contemplated that other vehicles, such as sport utility vehicles, may utilize the tire stowage assembly 40.

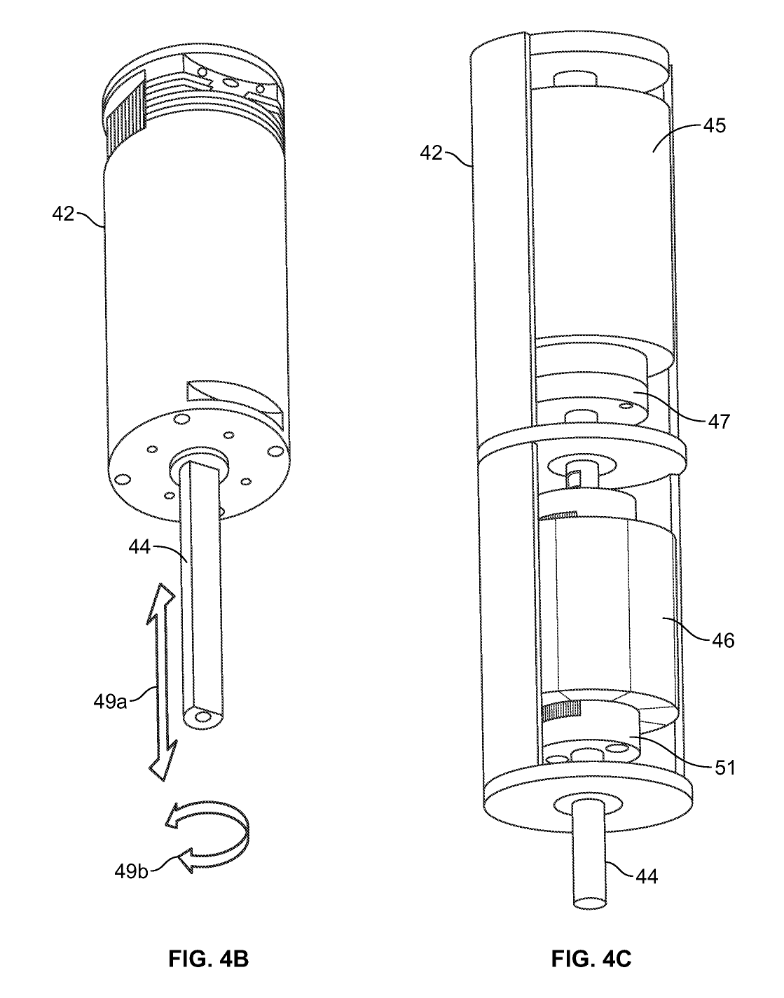

For example, a tire stowage assembly 40 may include a combination of actuators and mechanical linkages as shown in FIGS. 4A through 4C. The tire stowage assembly 40 may include a housing 42 secured to the frame 16. It is contemplated that the tire stowage assembly 40 may be secured to other portions of the vehicle 10, such as a body of the vehicle 10. It is also contemplated that the housing 42 may be secured to the frame 16 at different locations proximate or adjacent to the location of the spare tire 24. The housing 42 may define a housing cavity therein. The housing cavity may be sized to receive an output shaft 44. The output shaft 44 may be at least partially disposed within the housing 42 and have a connecting portion extending from the housing 42. The housing 42 and the output shaft 44 may operate as a linear-rotary actuator. FIGS. 4B and 4C show one example of a configuration for the linear-rotary actuator. In this example, a linear module 45 and a rotary module 46 may be retained within the housing 42 and have a series relationship between one another. The linear module 45 may include a coil translator 47 and the rotary module 46 may include a coil rotor 51. The output shaft 44 may be operably connected to the linear module 45 such that the coil translator 47 may facilitate linear movement of the output shaft 44. The output shaft 44 may be operably connected to the rotary module 46 such that the coil rotor 51 may facilitate rotational movement of the output shaft 44 about an axis 48 defined by the housing 42. Directional arrows 49a and 49b illustrate the linear and rotational movement of the output shaft 44, respectively.

The housing 42 may be oriented such that the linear movement of the output shaft 44 may be in a vertical or substantially vertical direction relative to the underlying surface upon which the vehicle 10 is supported. The output shaft 44 may also rotate about the axis 48 defined by the housing 42. One end of a slidable member, such as an arm 50, may be secured to the output shaft 44. In one example, the arm 50 may define an arm cavity sized to receive an extension member 54. An additional linear actuator may include the extension member 54 and the arm 50. The extension member 54 and the arm 50 may be arranged such that the extension member 54 may translate linearly with respect to the arm 50. For example, the extension member 54 may translate in a direction substantially perpendicular to the vertical direction in which the output shaft 44 linearly translates. A tire support rod 58 may be secured to a distal end of the extension member 54. The tire support rod 58 may define an axis 60 which is substantially parallel to the axis 48 defined by the housing 42. Another end of the tire support rod 58, such as an upper portion, may be threaded for mechanical engagement thereto. A support plate 64 may be secured to the tire support rod 58. The support plate 64 may be arranged to support the spare tire 24 when secured to the tire stowage assembly 40.

Referring back to FIGS. 1 through 3, the spare tire 24 is shown in a stowed position resting on the support plate 64 such that the tire support rod 58 extends through a center hole. A fastener, such as a bracket 68, may define an aperture threaded for mechanical engagement with the upper portion of the tire support rod 58. The bracket 68 may include a handle 72 to assist in rotating the bracket 68 to facilitate the mechanical engagement with the tire support rod 58. It is contemplated that other examples of fasteners may be used with the tire stowage assembly 40 to secure the spare tire 24 to the tire support rod 58. In the stowed position, the spare tire 24 is beneath the truck bed 14 as described above. The tire stowage assembly 40 may operate to lower and then present the spare tire 24 for access by a driver.

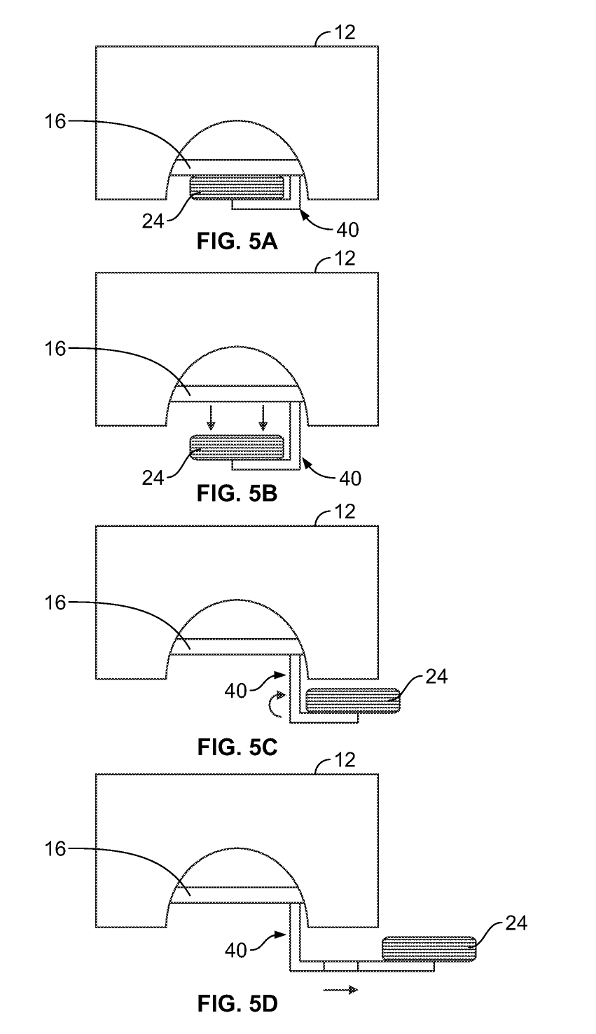

FIGS. 5A through 5D show an example of an operation in which the tire stowage assembly 40 may present the spare tire 24 for removal. In FIG. 5A, the spare tire 24 is in the stowed position. In FIG. 5B tire stowage assembly 40 has been activated such that the output shaft 44 translates linearly to move the spare tire 24 downward away from the frame 16. The tire stowage assembly 40 may lower the spare tire 24 a distance sufficient to create appropriate vertical clearance to clear the spare tire 24 of the frame 16 and other under body components such as a trailer tow hook or hitch. Various activation options are available to activate the tire stowage assembly 40 as described below. In FIG. 5C, the output shaft 44 has rotated to move the spare tire 24 to an intermediate position where extension member 54 is pointed toward a rear of the vehicle 10. In FIG. 5D, the extension member 54 has extended to translate laterally to move the spare tire 24 to a deployed position. In the deployed position, at least a portion of the spare tire 24 is exposed from underneath the vehicle 10. For example, in the deployed position the spare tire 24 may be positioned rearward of the undercarriage and be accessible by the driver such that the driver does not need to crawl underneath the vehicle 10 to rotate the bracket 68. Rather, the driver may now directly access the bracket 68 for removal and thus, be able to remove the spare tire 24 from the tire stowage assembly 40 for installation.

As mentioned above, various options are available to activate the tire stowage assembly 40. A mechanically activated option may include a crank (not shown) mechanically linked with the output shaft 44 to lower the spare tire 24 from the stowed position. A release (not shown) may then be triggered such that the spare tire 24 is rotated and such that the extension member 54 is accessible to pull the spare tire 24 into the deployed position. An electrically activated option may include a power source (not shown), such as a battery, electrically connected to the vertical linear-rotary actuator, the lateral linear actuator of the tire stowage assembly 40, and a switch (not shown). The switch may be in communication with the actuators. The switch may be located, for example, within a vehicle cabin. The switch may be integrated with a remote device, such as a key fob for the vehicle 10. It is contemplated that other suitable locations are available for the switch. The switch may be triggered to activate the tire stowage assembly 40. In this example, triggering the switch may initiate movement of the linear-rotary actuator and the linear actuator to move the spare tire 24 through multiple positions including the stowed position as shown in FIG. 5A and the deployed position as shown in FIG. 5D. It is contemplated that one or more sensors may be integrated with the tire stowage assembly 40 to detect obstacles in a path of the tire stowage assembly 40 during deployment or stowage of the spare tire 24. The tire stowage assembly 40 may be configured to stall or cease movement when the one or more sensors detect the obstacle.

While various embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A tire stowage assembly comprising:
a housing for securing to an inner surface of a vehicle frame member and defining a receiving cavity;
an output shaft at least partially disposed within the housing and configured for linear translation and rotation;
an arm extending laterally from the shaft; and
a slidable member operably connected to the arm for linear translation and configured to support a spare tire,
wherein the output shaft and slidable member are further configured to cooperate to move the tire from a stowed to a deployed position.

2. The assembly of claim 1, wherein the stowed position is defined as a position in which the spare tire is secured beneath an undercarriage of a vehicle.

3. The assembly of claim 1, wherein the deployed position is defined as a position in which at least a portion of the spare tire is rearward of an undercarriage of a vehicle and such that an upper surface of the tire defines a plane substantially parallel to an underlying surface.

4. The assembly of claim 1, further comprising:
a support rod secured to the slidable member and defining an upper portion for receiving the spare tire;
a support plate shaped as a disc and secured to the support rod below the upper portion; and
a bracket configured to fasten to the upper portion such that the spare tire is disposed between the support plate and the bracket.

5. The assembly of claim 1, further comprising:
a linear-rotary actuator operably connected to the output shaft;
a linear actuator operably connected to the slidable member;
a power source electrically connected to the actuators; and
a switch in communication with the actuators such that a triggering of the switch activates the actuators for a powered delivery of the tire to the deployed position.

6. The assembly of claim 5, wherein the linear-rotary actuator is configured to lower the spare tire a distance such that the spare tire clears any adjacent vehicle components when transitioning to the deployed position.

7. A tire stowage assembly comprising:
a first actuator including an output shaft, configured for securing to an inner surface of a vehicle frame member, and configured to rotate and linearly translate the shaft; and
a second actuator extending laterally from the shaft and including a slidable member configured to support a spare tire,
wherein the actuators cooperate with one another to move the spare tire from a stowed position adjacent to the vehicle frame member to a deployed position at least partially rearward of a vehicle undercarriage.

8. The assembly of claim 7, further comprising a support rod extending from the slidable member and defining a rod axis, and wherein the output shaft defines a shaft axis at least substantially parallel to the rod axis.

9. The assembly of claim 7, wherein the undercarriage and an underlying surface define a region therebetween, and wherein the slidable member is further configured to translate linearly to move at least a portion of the spare tire outside of the region.

10. The assembly of claim 7, wherein the stowed position is further defined as a position in which the spare tire is secured substantially close to the undercarriage.

11. The assembly of claim 7, wherein the deployed position is further defined as a position in which at least a portion of the spare tire is rearward of the undercarriage.

12. The assembly of claim 7, further comprising:
a power source electrically connected to the actuators; and
a switch in communication with the actuators such that triggering the switch activates the actuators for a powered delivery of the tire between the stowed and the deployed positions.

13. The assembly of claim 12, wherein the switch is located within a vehicle cabin or is integrated with a remote device.

14. A vehicle comprising:
a frame; and
a tire stowage assembly including operably connected linear-rotary and linear actuators configured to support a spare tire in a stowed and a deployed position, wherein the linear-rotary actuator is affixed to an interior surface of the frame to provide vertical translation and rotation to lower and pivot the spare tire from the stowed position, and extension of the linear actuator delivers the tire to the deployed position.

15. The vehicle of claim 14, further comprising a switch to control power flow to the actuators such that triggering the switch activates a powered delivery of the tire between the stowed and deployed positions.

16. The vehicle of claim 14, wherein the stowed position is further defined as a position in which the spare tire is secured proximate to an undercarriage of the vehicle.

17. The vehicle of claim 16, wherein the deployed position is further defined as a position in which the spare tire is at least partially disposed rearward of the vehicle.

18. The vehicle of claim 14, wherein the linear-rotary actuator comprises:
a housing affixed to an undercarriage of the vehicle; and
an output shaft at least partially disposed within the housing and configured to move an arm supporting the spare tire a distance such that the spare tire is below the undercarriage.

19. The vehicle of claim 14, wherein the linear actuator comprises a slidable member configured to translate the spare tire rearward of an undercarriage of the vehicle.

20. The vehicle of claim 14, further comprising:
a support rod secured to a slidable member of the linear actuator and defining an upper portion to support the spare tire;
a support plate shaped as a disc and secured to the slidable member below the upper portion; and
a handle configured to fasten to the upper portion such that the spare tire is retained between the support plate and handle.
